(19) United States
(12) Patent Application Publication
(10) Pub. No.: US 2006/0013930 A1
(43) Pub. Date: Jan. 19, 2006

(54) Method and means for decorating bakery goods

(76) Inventor: Lawrence D. Anthony, Spring Hill, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/894,318

(22) Filed: Jul. 19, 2004

(51) Int. Cl. A22C 17/10

(52) U.S. Cl. 426/383

(57) ABSTRACT

A device for decorating bakery goods is provided that includes a basin having a bottom and sides. A turntable is provided that is rotatably mounted to the bottom of the basin. Additionally, at least one retainer is provided, the retainer being secured to the turntable. The present invention also is directed toward a method of decorating bakery goods on a turntable having at least one retainer. A bakery good is secured to the turntable with the retainer. The bakery good is then decorated with frosting as the turntable rotates.

### BACKGROUND OF THE INVENTION

The present invention relates to bakery goods and, more specifically, a method and means for decorating bakery goods with frosting.

In recent years, spin art has become increasingly popular, particularly among children. In creating spin art, a small card or disc, which serves as a painter's canvas, is rotated while the artist or child applies paint. As the card or disc rotates, the paint sprays outwardly in a radial pattern, creating unique and interesting patterns. Because of the nature of spin art, the artist or child need not be artistically inclined to create a work of art. To date, the concept of spin art has only been applied to cards and discs for creating visually stimulating paintings.

Bakery goods such as cookies have long been decorated with frosting. Not only does frosting improve the taste of the bakery good, but frosting also serves to dress up the bakery good to create a visually pleasing treat. For example, frosting is often used on cookies to create smiley faces and the like. The disadvantage with applying frosting to a bakery good is that doing so often requires artistic talent. Accordingly, there is a need in the art for an improved method of applying frosting to bakery goods that does not require artistic talent to achieve a visually pleasing treat.

It is therefore a principal object of this invention to provide a method and means of decorating bakery goods with frosting that does not require artistic talent.

A further object of this invention is to provide a method and means of decorating bakery goods with frosting that is fun and entertaining.

Still a further object of this invention is to provide a device that secures and rotates a bakery good as frosting is applied to decorate the bakery good.

These and other objects will be apparent to those skilled in the art.

### BRIEF SUMMARY OF THE INVENTION

The present invention is directed toward a device for decorating bakery goods that includes a basin having a bottom and sides. A turntable is provided that is rotatably mounted to the bottom of the basin. Additionally, at least one retainer is provided, the retainer being secured to the turntable.

The present invention also is directed toward a method of decorating bakery goods on a turntable having at least one retainer. A bakery good is secured to the turntable with the retainer. The bakery good is then decorated with frosting as the turntable rotates.

### BRIEF DESCRIPTION OF THE DRAWINGS

FIG. 1 is a perspective view of an embodiment of the present invention;

FIG. 2A is a plan view of a turntable of the present invention;

FIG. 2B is a plan view of another turntable of the present invention;

FIG. 2C is a plan view of another turntable of the present invention;

FIG. 3 is a sectional view of the retainer of the present invention;

FIG. 3A is the retainer of FIG. 3 as shown securing a bakery good; and

FIG. 4 is a perspective view of another embodiment of the present invention.

### DESCRIPTION OF THE PREFERRED EMBODIMENTS OF THE INVENTION

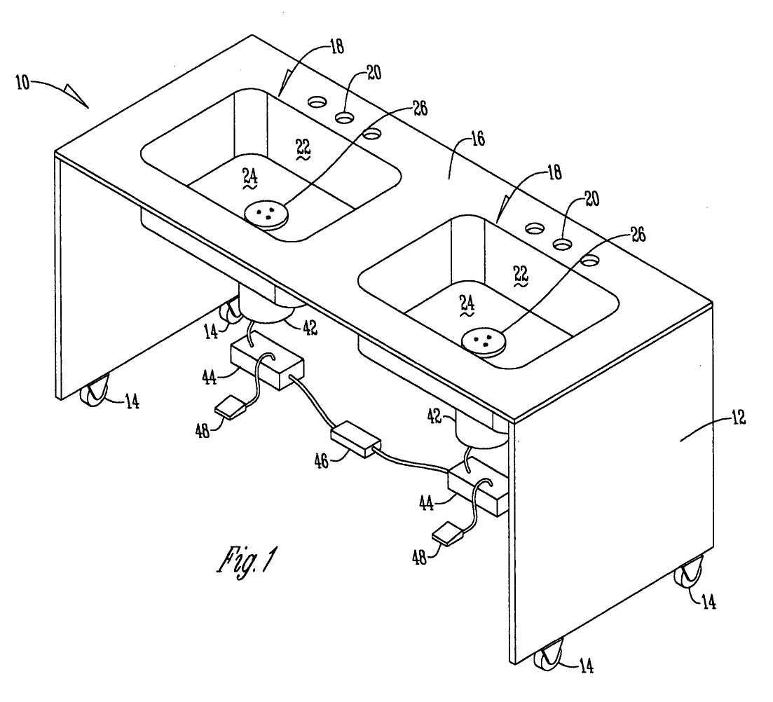

With reference to FIG. 1, a device 10 is shown for use with decorating bakery goods such as cookies. The decorating device 10 includes a frame 12 supported on casters or wheels 14 and having a top surface 16. The top surface 16 includes a pair of basins 18 and multiple recesses 20 for holding containers of frosting (not shown).

Basin 18 is comprised of sides 22 and a bottom 24. Although the preferred embodiment has a pair of basins 18, it is contemplated that the decorating device 10 could have any number of basins 18. Preferably, basin 18 is similar in size to a conventional kitchen sink.

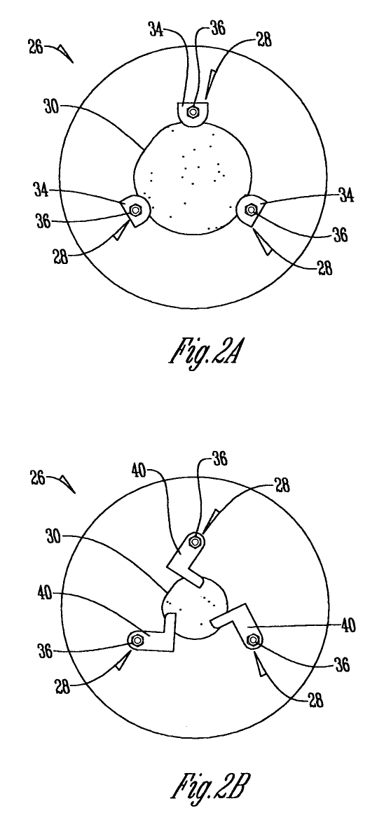

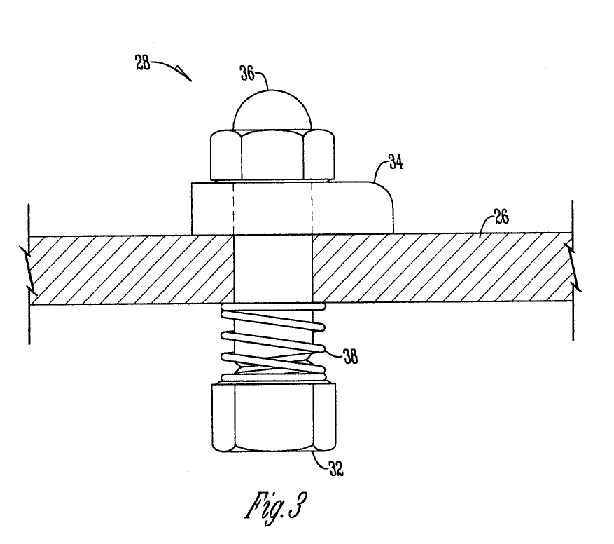

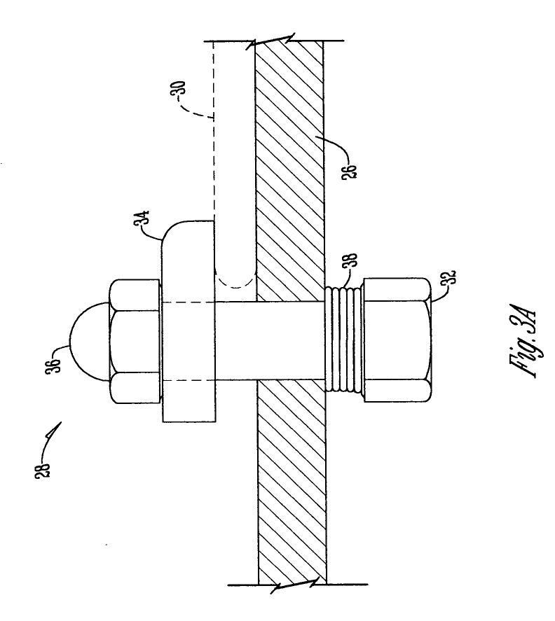

A turntable 26 is rotatably mounted to the bottom 24 of the basin 18 and has at least one retainer 28. Preferably, the turntable 26 has three retainers 28 arranged in a circular configuration and spaced approximately 120° apart, as shown in FIGS. 2A and 2B. Alternatively, the turntable 26 has a single retainer (not shown) secured to the center of the turntable 26 that secures a bakery good, such as cookie 30, about its center. The retainers 28 are adjustable to secure bakery goods of various sizes, such as cookie 30, to the turntable 26.

With respect to FIG. 2C, a retaining dish 31 is secured to the turntable 26 for holding the bakery good. The retaining dish has sides 33 of sufficient height to hold and retain the bakery good, such as cookie 30, as the turntable 26 rotates. As such, no separate retainers are required with the retaining dish 31.

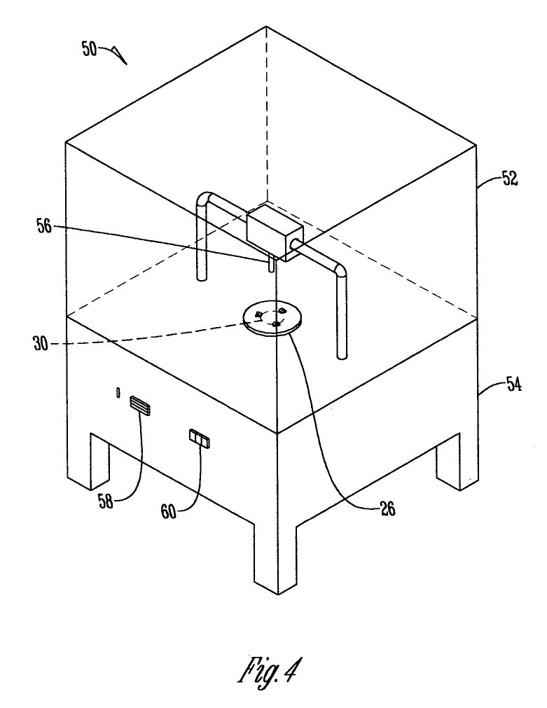

Retainer 28 is comprised of a bolt 32 that extends upwardly through the turntable 26, as shown in FIG. 3. Bolt 32 also extends through a clip member 34, which is retained by a cap or nut 36 threadably secured to the bolt 32. A compression spring 38 fits between the head of the bolt 32 and the turntable 26 and biases the bolt in a downward position, as shown in FIG. 3. In this manner, the bolt 32 pulls the nut 36 downwardly such that the clip member 34 is placed against the turntable 26.

Clip member 34 is generally semi-circular in shape, as shown in FIG. 2A. In this manner, the retainer 28 can be lifted upwardly with respect to the turntable 26, allowing the clip member 34 to pivot about the bolt 32 for proper placement of the clip member 34 on the bakery good 30, as shown in FIG. 3A. The force of the spring 38 pulls the bolt 32 downwardly with respect to the turntable 26, allowing the clip member 34 to secure the bakery good 30 to the turntable 26.

Alternatively, retainer 28 includes a generally L-shaped clip member 40, as shown in FIG. 2B. In this manner, the clip member 40 can be used to secure bakery goods 30 of smaller size or irregular shape. Specifically, because the clip member 40 is L-shaped, the clip member 40 can secure bakery goods 30 of various sizes by pivoting the clip member 40 about bolt 32 until the clip member 40 is properly positioned on the bakery good 30.

A motor 42 rotates the turntable 26, as shown in FIG. 1. Preferably, motor 42 is electric, but any conventional motor may be used. Motor 42 is operatively connected to a power source 44. Preferably, the power source 44 is a 6V battery that can be recharged by charger 46. However, any conventional power source may be used.

The rotation of the turntable 26 is controlled by a foot pedal 48 operatively connected to the power source 44. In this arrangement, the foot pedal 48, which serves as a switch, interrupts the electrical connection between the power source 44 and the motor 42 driving the turntable 26. Activation of the foot pedal 48 turns the motor 42 on or off, thereby varying the rotation of the turntable 26. Alternatively, the power source 44 may be equipped with a timer or similar device that operates the motor 42 for a preset amount of time. In this manner, the need for a foot pedal 48 is eliminated.

With reference to FIG. 4, an alternative embodiment 50 of the bakery good decorating device is shown. The decorating device 50 includes a glass housing 52 supported by a frame 54. In this embodiment, the decorating device 50 is automated whereby the turntable 26 rotates for a preset amount of time while frosting is applied to the bakery good 30 by an overhead nozzle 56. A consumer activates the decorating device 50 by inserting money into a coin slot or bill reader 58 and controls the color of frosting applied by selecting buttons 60. Because the operation is automated, decorating device 50 may be used in any number of commercial venues. Additionally, because of the glass housing 52, the turntable 26 and other components of the decorating device 50 are protected from non-sanitary conditions.

In operation, the decorating device 10 allows a consumer to uniquely decorate cookies and other bakery goods 30 with frosting. Specifically, a consumer places a cookie or bakery good 30 on the turntable 26. The consumer then secures the bakery good 30 to the turntable 26 by adjusting the retainers 28 such that the clip members 34 are properly placed upon the bakery good 30. The retainers 28 apply sufficient force to hold the bakery good 30 in place during rotation without breaking the bakery good. The turntable 26 is rotated by a motor 42 operatively connected to a power source 44. Rotation of the turntable 26 is controlled either by a foot pedal 48 or by a timer incorporated into the power source 44. As the turntable 26 and bakery good 30 rotate, the consumer uses frosting to decorate the bakery good 30. Preferably, the frosting is a glaze having the viscosity of a thick liquid that is heated above room temperature. As the heating frosting impacts the bakery good 30, the temperature differential between the frosting and the bakery good 30 causes the frosting to quickly harden upon the bakery good 30. Because the bakery good 30 is rotating with respect to the frosting, the frosting spreads across the bakery good 30 in a radial fashion. By using different colored frostings, a consumer can create a unique and visually pleasing bakery good 30. After the turntable 26 stops rotating, the consumer removes the bakery good 30 from the turntable 26 by releasing the retainers 28. The consumer is then able to enjoy the unique bakery treat.

It is therefore seen that by the use of a turntable with a plurality of retainers, this invention provides for the unique decoration of bakery goods with frosting as the turntable rotates.

What is claimed is:

1. A device for decorating bakery goods comprising:
a turntable; and
at least one retainer secured to the turntable.

2. The device of claim 1 wherein the retainer comprises a spring-loaded bolt extending through the turntable, and a clip member mounted on the bolt such that the bolt biases the clip member against the turntable.

3. The device of claim 2 wherein the clip member is semi-circular in shape.

4. The device of claim 2 wherein the clip member is generally L-shaped.

5. The device of claim 1 further comprising a motor operatively connected to the turntable.

6. The device of claim 5 wherein the motor is powered by a battery.

7. The device of claim 5 wherein the motor is operatively connected to a foot pedal.

8. The device of claim 5 wherein the motor is operatively connected to a timer.

9. The device of claim 1 wherein the turntable is disposed within a glass housing.

10. A method of decorating bakery goods comprising the steps of:
providing a turntable having at least one retainer;
securing a bakery good to the turntable with the retainer;
rotating the turntable; and
decorating the bakery good with frosting as the turntable rotates.

11. The method of claim 10 wherein the frosting is a heated glaze that hardens upon impact of the bakery good.

12. The method of claim 10 wherein the retainer is adjustable.

13. The method of claim 10 wherein the rotation of the turntable is controlled by a foot pedal.

14. The method of claim 10 wherein the turntable rotates for a preset time.
